(19) United States
(12) Patent Application Publication
(10) Pub. No.: US 2025/0071628 A1
(43) Pub. Date: Feb. 27, 2025

(54) METHODS AND APPARATUSES FOR HANDLING A MOBILITY CONFIGURATION UPON RECEPTION OF NOTIFICATION MESSAGE

(71) Applicant: Lenovo (Beijing) Limited, Beijing (CN)

(72) Inventors: Lianhai Wu, Beijing (CN); Haiming Wang, Beijing (CN); Ran Yue, Beijing (CN); Jing Han, Beijing (CN)

(73) Assignee: Lenovo (Beijing) Limited, Beijing (CN)

(21) Appl. No.: 18/724,709

(22) PCT Filed: Feb. 13, 2022
(86) PCT No.: PCT/CN2022/076128

§ 371 Date: Jun. 27, 2024

(51) Int. Cl. H04W 36/00; H04W 36/36

(52) U.S. Cl. CPC H04W 36/0058; H04W 36/033; H04W 36/362

(57) ABSTRACT

Embodiments of the present application relate to methods and apparatuses of handling a mobility configuration upon a reception of a notification message in a layer-2 (L2) UE-to-Network (U2N) relay case. According to an embodiment of the present application, a user equipment (UE) includes a processor and a transceiver coupled to the processor: and the processor is configured: to access a serving cell via a direct path or an indirect path, wherein the indirect path is associated with a relay UE; and to receive an radio resource control (RRC) reconfiguration message via the transceiver from the serving cell, wherein the RRC reconfiguration message includes at least one indication of: a measurement configuration; a conditional handover (CHO) configuration associated with at a candidate cell; an indication indicating whether the UE is triggered to report a measurement result of a candidate relay UE in response to identifying a cell change of the candidate relay UE; or a relay operation related configuration used by remote UE in response to accessing the serving cell via the indirect path.

### TECHNICAL FIELD

Embodiments of the present application generally relate to wireless communication technology, in particular to methods and apparatuses of handling a mobility configuration upon a reception of a notification message in a layer-2 (L2) UE-to-Network (U2N) relay case.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a user equipment (UE) that is located in the coverage or far from the BS, which can result in relatively low signal quality. A RN may also be named as a relay UE in some cases. A 3GPP 5G sidelink system including a relay UE may be named as a sidelink relay system. A U2N relay UE is a UE that provides functionality to support connectivity to the network for U2N remote UE(s).

Currently, in a wireless communication system or the like, details regarding handling a mobility configuration upon a reception of a notification message in a L2 U2N relay case have not been specifically discussed yet.

### SUMMARY

Some embodiments of the present application provide a user equipment (UE). The UE includes a processor and a transceiver coupled to the processor; and the processor is configured: to access a serving cell via a direct path or an indirect path, wherein the indirect path is associated with a relay UE; and to receive an radio resource control (RRC) reconfiguration message via the transceiver from the serving cell, wherein the RRC reconfiguration message includes at least one indication of: a measurement configuration; a conditional handover (CHO) configuration associated with at a candidate cell; an indication indicating whether the UE is triggered to report a measurement result of a candidate relay UE in response to identifying a cell change of the candidate relay UE; or a relay operation related configuration used by remote UE in response to accessing the serving cell via the indirect path.

In some embodiments, the processor of the UE is configured to receive a notification message via the transceiver from the relay UE, and the notification message includes at least one indication of: the relay UE handover; an radio link failure (RLF) on a Uu link of the relay UE; a cell selection or reselection of the relay UE; a rejection of radio resource control (RRC) connection establishment; or an RRC connection establishment failure.

In some embodiments, the RRC reconfiguration message including the CHO configuration is received via the indirect path from the serving cell, and the processor of the UE is configured to start to evaluate at least one execution condition associated with the candidate cell in response to the RRC reconfiguration message including the CHO configuration.

In some embodiments, in response to receiving the notification message from the relay UE, the processor of the UE is configured: to stop to evaluate the at least one execution condition; or to continue to evaluate the at least one execution condition, and not execute a CHO upon the at least one execution condition being fulfilled.

In some embodiments, the processor of the UE is configured to receive a message to release a PC5 RRC connection via the transceiver from the relay UE.

In some embodiments, the processor of the UE is configured to initiate an RRC reestablishment procedure, in response to: receiving the notification message including at least one indication of: the relay UE handover; an radio link failure (RLF) on a Uu link of the relay UE; a cell selection or reselection of the relay UE; the RRC establishment procedure failure, or the rejection of RRC establishment procedure; or receiving the message to release a PC5 RRC connection from the relay UE.

In some embodiments, the processor of the UE is configured to release the relay operation related configuration used by remote UE, in response to: the RRC reconfiguration message including the relay operation related configuration used by remote UE; an RRC reestablishment procedure being initiated; and the RRC reconfiguration message not including the CHO configuration.

In some embodiments, the processor of the UE is configured: in response to initiating the RRC reestablishment procedure, to perform a cell selection; and in response to the RRC reconfiguration message including the relay operation related configuration used by remote UE, in response to a CHO configuration being configured to the remote UE and in response to the selected cell being not a CHO candidate cell, to release the relay operation related configuration used by remote UE.

In some embodiments, the processor of the UE is configured to report one or more measurement results of one or more candidate relay UEs via the indirect path to the serving cell, wherein the one or more measurement results of the one or more candidate relay UEs include a measurement result of the candidate relay UE, and wherein the measurement result of the candidate relay UE includes at least one of: a channel quality of a link between the UE and the candidate relay UE; identity (ID) information of the candidate relay UE; or ID information of a first serving cell of the candidate relay UE.

In some embodiments, the processor of the UE is configured to trigger to report the measurement result of the candidate relay UE, in response to identifying a cell change of the candidate relay UE after reporting the one or more measurement results including the measurement result of the candidate relay UE.

In some embodiments, the processor of the UE is configured to receive a discovery message including identity (ID) information of a second serving cell of the candidate relay UE via the transceiver from the candidate relay UE.

In some embodiments, the measurement result of the candidate relay UE includes the ID information of the second serving cell, and wherein the cell change of the candidate relay UE is identified after receiving the discovery message.

Some embodiments of the present application provide a relay UE. The relay UE includes a processor and a transceiver coupled to the processor; and the processor is configured: to receive an radio resource control (RRC) reconfiguration message via the transceiver from a serving cell, wherein the RRC reconfiguration message includes at least one of: a conditional handover (CHO) configuration associated with a candidate cell; or a relay operation related configuration used by relay UE; and to transmit a notification message via the transceiver to a remote UE via a PC5 link, when at least one of following conditions is fulfilled: upon declaring an radio link failure (RLF) on a Uu link of the relay UE; upon a reception of an radio resource control (RRC) reconfiguration message including a reconfiguration synchronization information element (IE); upon an execution of a handover; upon an execution of a conditional handover (CHO); upon a cell selection or reselection of the relay UE; upon a rejection from a serving cell for establishing an RRC connection between the relay UE and the serving cell; or upon an RRC connection establishment failure.

In some embodiments, the notification message includes at least one indication of: the relay UE handover; the RLF on the Uu link of the relay UE; the cell selection or reselection of the relay UE; a rejection of RRC connection establishment; or an RRC connection establishment failure.

In some embodiments, the processor of the relay UE is configured to transmit a message to release a PC5 RRC connection via the transceiver to the remote UE, upon the rejection from the serving cell for establishing the RRC connection.

Some embodiments of the present application provide a network node (e.g., a BS). The network node includes a processor and a transceiver coupled to the processor; and the processor is configured: to transmit an radio resource control (RRC) reconfiguration message via the transceiver to a user equipment (UE) via a direct path or an indirect path, wherein the indirect path is associated with a relay UE, and wherein the RRC reconfiguration message includes at least one indication of: a measurement configuration; a conditional handover (CHO) configuration associated with at a candidate cell; or an indication indicating whether the UE is triggered to report a measurement result of a candidate relay UE in response to identifying a cell change of the candidate relay UE.

In some embodiments, the processor of the network node is configured to receive one or more measurement results of one or more candidate relay UEs via the transceiver from the UE via the indirect path, wherein the one or more measurement results of the one or more candidate relay UEs include a measurement result of the candidate relay UE, and wherein the measurement result of the candidate relay UE includes at least one of: a channel quality of a link between the UE and the candidate relay UE; identity (ID) information of the candidate relay UE; or ID information of a first serving cell of the candidate relay UE.

In some embodiments, the processor of the network node is configured to receive the measurement result of the candidate relay UE via the transceiver from the UE, in response to the UE identifying a cell change of the candidate relay UE.

In some embodiments, the measurement result of the candidate relay UE includes identity (ID) information of a second serving cell of the candidate relay UE, and wherein the cell change of the candidate relay UE is identified after the UE receiving a discovery message

Some embodiments of the present application provide a method, which may be performed by a UE. The method includes: accessing a serving cell via a direct path or an indirect path, wherein the indirect path is associated with a relay UE; and receiving an radio resource control (RRC) reconfiguration message from the serving cell, wherein the RRC reconfiguration message includes at least one indication of: a measurement configuration; a conditional handover (CHO) configuration associated with at a candidate cell; an indication indicating whether the UE is triggered to report a measurement result of a candidate relay UE in response to identifying a cell change of the candidate relay UE; or a relay operation related configuration used by remote UE in response to accessing the serving cell via the indirect path.

In some embodiments, the method further comprises receiving a notification message from the relay UE, wherein the notification message includes at least one indication of: the relay UE handover; an radio link failure (RLF) on a Uu link of the relay UE; a cell selection or reselection of the relay UE; a rejection of radio resource control (RRC) connection establishment; or an RRC connection establishment failure.

In some embodiments, the RRC reconfiguration message including the CHO configuration is received via the indirect path from the serving cell, and the method further comprises: starting to evaluate at least one execution condition associated with the candidate cell in response to the RRC reconfiguration message including the CHO configuration.

In some embodiments, the method further comprises, in response to receiving the notification message from the relay UE: stopping to evaluate the at least one execution condition; or continuing to evaluate the at least one execution condition, and not executing a CHO upon the at least one execution condition being fulfilled.

In some embodiments, the method further comprises receiving a message to release a PC5 RRC connection from the relay UE.

In some embodiments, the method further comprises initiating an RRC reestablishment procedure, in response to: receiving the notification message including at least one indication of: the relay UE handover; an radio link failure (RLF) on a Uu link of the relay UE; a cell selection or reselection of the relay UE; the RRC establishment procedure failure, or the rejection of RRC establishment procedure; or receiving the message to release a PC5 RRC connection from the relay UE.

In some embodiments, the method further comprises releasing the relay operation related configuration used by remote UE, in response to: the RRC reconfiguration message including the relay operation related configuration used by remote UE; an RRC reestablishment procedure being initiated; and the RRC reconfiguration message not including the CHO configuration.

In some embodiments, the method further comprises in response to initiating the RRC reestablishment procedure, performing a cell selection; in response to the RRC reconfiguration message including the relay operation related configuration used by remote UE, in response to a CHO configuration being configured to the remote UE and in response to the selected cell being not a CHO candidate cell, releasing the relay operation related configuration used by remote UE.

In some embodiments, the method further comprises reporting one or more measurement results of one or more candidate relay UEs via the indirect path to the serving cell, wherein the one or more measurement results of the one or more candidate relay UEs include a measurement result of the candidate relay UE, and wherein the measurement result of the candidate relay UE includes at least one of: a channel quality of a link between the UE and the candidate relay UE; identity (ID) information of the candidate relay UE; or ID information of a first serving cell of the candidate relay UE.

In some embodiments, the method further comprises triggering to report the measurement result of the candidate relay UE, in response to identifying a cell change of the candidate relay UE after reporting the one or more measurement results including the measurement result of the candidate relay UE.

In some embodiments, the method further comprises receiving a discovery message including identity (ID) information of a second serving cell of the candidate relay UE from the candidate relay UE.

In some embodiments, the measurement result of the candidate relay UE includes the ID information of the second serving cell, and wherein the cell change of the candidate relay UE is identified after receiving the discovery message.

Some embodiments of the present application provide a method, which may be performed by a relay UE. The method includes: receiving an radio resource control (RRC) reconfiguration message from a serving cell, wherein the RRC reconfiguration message includes at least one of: a conditional handover (CHO) configuration associated with a candidate cell; or a relay operation related configuration used by relay UE; and transmitting a notification message to a remote UE via a PC5 link, when at least one of following conditions is fulfilled: upon declaring an radio link failure (RLF) on a Uu link of the relay UE; upon a reception of an radio resource control (RRC) reconfiguration message including a reconfiguration synchronization information element (IE); upon an execution of a handover; upon an execution of a conditional handover (CHO); upon a cell selection or reselection of the relay UE; upon a rejection from a serving cell for establishing an RRC connection between the relay UE and the serving cell; or upon an RRC connection establishment failure.

In some embodiments, the notification message includes at least one indication of: the relay UE handover; the RLF on the Uu link of the relay UE; the cell selection or reselection of the relay UE; a rejection of RRC connection establishment; or an RRC connection establishment failure.

In some embodiments, the method further comprise transmitting a message to release a PC5 RRC connection to the remote UE upon the rejection from the serving cell for establishing the RRC connection.

Some embodiments of the present application provide a method, which may be performed by a network node (e.g., a BS). The method includes: transmitting an radio resource control (RRC) reconfiguration message to a user equipment (UE) via a direct path or an indirect path, wherein the indirect path is associated with a relay UE, and wherein the RRC reconfiguration message includes at least one indication of: a measurement configuration; a conditional handover (CHO) configuration associated with at a candidate cell; or an indication indicating whether the UE is triggered to report a measurement result of a candidate relay UE in response to identifying a cell change of the candidate relay UE.

In some embodiments, the method further comprises receiving one or more measurement results of one or more candidate relay UEs from the UE via the indirect path, wherein the one or more measurement results of the one or more candidate relay UEs include a measurement result of the candidate relay UE, and wherein the measurement result of the candidate relay UE includes at least one of: a channel quality of a link between the UE and the candidate relay UE; identity (ID) information of the candidate relay UE; or ID information of a first serving cell of the candidate relay UE.

In some embodiments, the method further comprises receiving the measurement result of the candidate relay UE from the UE, in response to the UE identifying a cell change of the candidate relay UE.

In some embodiments, the measurement result of the candidate relay UE includes identity (ID) information of a second serving cell of the candidate relay UE, and wherein the cell change of the candidate relay UE is identified after the UE receiving a discovery message.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE, a relay UE, or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flowchart of a sidelink RRC reconfiguration procedure in accordance with some embodiments of the present application.

FIG. 3 illustrates a flow chart of an exemplary procedure of wireless communications in accordance with some embodiments of the present disclosure.

FIG. 4 illustrates a flow chart of an exemplary procedure of wireless communications in accordance with some embodiments of the present disclosure.

FIG. 5 illustrates a flow chart of an exemplary procedure of wireless communications in accordance with some embodiments of the present disclosure.

FIG. 6 illustrates an exemplary block diagram of an apparatus for a L2 U2N relay case according to some embodiments of the present application.

FIG. 7 illustrates a further exemplary block diagram of an apparatus for a L2 U2N relay case according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

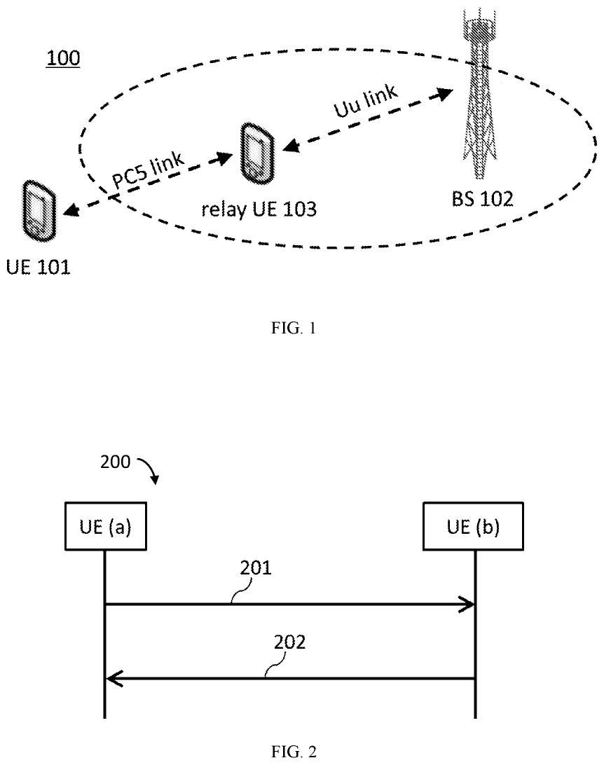

FIG. 1 illustrates a schematic diagram of a wireless communication system 100 in accordance with some embodiments of the present application. As shown in FIG. 1, the wireless communication system 100 includes UE 101, BS 102, and relay UE 103 for illustrative purpose. Although a specific number of UE(s), relay UE(s), and BS(s) are depicted in FIG. 1, it is contemplated that any number of UE(s), relay UE(s), and BS(s) may be included in the wireless communication system 100.

Due to a far distance between UE 101 and BS 102, these they communicate with each other via relay UE 103. UE 101 may be connected to relay UE 103 via a network interface, for example, a PC5 interface as specified in 3GPP standard documents. Relay UE 103 may be connected to BS 102 via a network interface, for example, a Uu interface as specified in 3GPP standard documents. Referring to FIG. 1, UE 101 is connected to relay UE 103 via a PC5 link, and relay UE 103 is connected to BS 102 via a Uu link. UE 101 may be a U2N remote UE. Relay UE 103 may be a U2N relay UE, which is a UE that provides functionality to support connectivity to the network for U2N remote UE(s).

In some embodiments of the present application, UE 101 or relay UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

In some further embodiments of the present application, UE 101 or relay UE 103 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 or relay UE 103 may include wearable devices, such as smart watches, fitness bands, optical head-mounted displays, or the like. Moreover, UE 101 or relay UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of an radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL), and UE(s) 101 (e.g., UE 101 or other similar UE) transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 702.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a Physical Downlink Control Channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

BS(s) 102 may include one or more cells. UE(s) 101 may perform a cell section procedure between different cell(s) of different BS(s). UE(s) 101 may handover from a serving cell of a source BS to a target cell of a target BS. For example, in the wireless communication system 100 as illustrated and shown in FIG. 1, BS 102 as illustrated and shown in FIG. 1 may function as a source BS, and a further BS 102 (not shown in FIG. 1) may function as a target BS. If there is a handover need, UE 101 as illustrated and shown in FIG. 1 may perform a handover procedure from a serving cell of BS 102 to a target cell of the further BS, which depends on the measurement result. The handover procedure performed by UE 101 may be a CHO procedure.

As specified in 3GPP standard documents, CHO is defined as a handover that is executed by a UE when one or more handover execution conditions are met. The UE starts evaluating the execution condition(s) upon receiving the CHO configuration, and stops evaluating the execution condition(s) during the CHO procedure once the execution condition(s) is met.

FIG. 2 illustrates an exemplary flowchart of a sidelink RRC reconfiguration procedure in accordance with some embodiments of the present application. As shown in FIG. 2, in step 201, UE (a) (e.g., UE 101 as illustrated and shown in FIG. 1) initiates a sidelink RRC reconfiguration procedure to UE (b) (e.g., relay UE 102 as illustrated and shown in FIG. 1) by transmitting RRC ReconfigurationSidelink message to UE (b).

If the sidelink RRC reconfiguration procedure is successfully completed, in step 202, UE (b) may transmit “an RRC reconfiguration complete sidelink message” to UE (a), e.g., RRCReconfigurationCompleteSidelink message as specified in 3GPP standard documents. Alternatively, if the sidelink RRC reconfiguration procedure is not successfully completed, in step 202, UE (b) may transmit “an RRC reconfiguration failure sidelink message” to UE (a), e.g., RRCReconfigurationFailureSidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE (a) as illustrated and shown in FIG. 2) may initiate the sidelink RRC reconfiguration procedure and perform operations on the corresponding PC5 RRC connection in following cases:
a release of sidelink DRBs associated with a peer UE (e.g., UE (b) as illustrated and shown in FIG. 2);
an establishment of sidelink DRBs associated with the peer UE;
a modification for the parameters included in Sidelink radio bearer (SLRB)-Config of sidelink DRBs associated with the peer UE;
configuration information of the peer UE to perform NR sidelink measurement and report; and
configuration information of the sidelink CSI reference signal resources.

A UE capable of NR sidelink communication may initiate a procedure of sidelink UE information for NR, to report to a network or a BS that a sidelink radio link failure (RLF) (e.g., timer T400 expiry) or a sidelink RRC reconfiguration failure has been declared.

Embodiments of the present application aim to solve issues in a L2 U2N relay case. For example, some embodiments of the present application study a mechanism for a case in which CHO configuration(s) is configured to a remote UE and/or a relay UE. Some embodiments of the present application study a mechanism for a case in which a relay UE (re-)selects to another cell after a remote UE reports measurement result(s). Some embodiments of the present application study new behaviour(s) and/or indication(s) of a remote UE and a relay UE in a direct-to-indirect path switch case or an indirect-to-indirect path switch case in which the relay UE may fail to establish a Uu connection.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

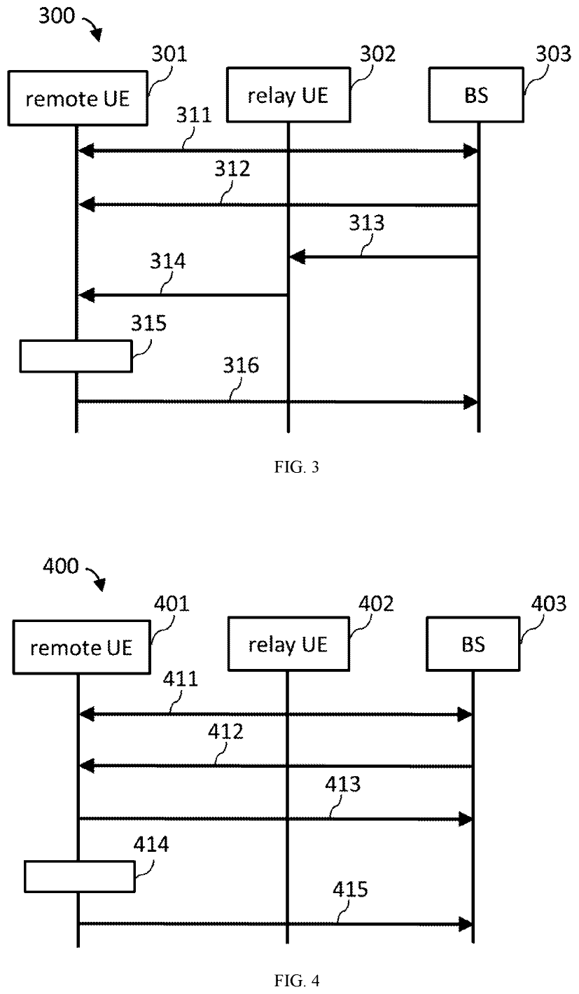

FIG. 3 illustrates a flow chart of an exemplary procedure 300 of wireless communications in accordance with some embodiments of the present disclosure. Details described in all other embodiments of the present disclosure are applicable for the embodiments shown in FIG. 3.

Exemplary procedure 300 refers to a scenario, which handles the case that a relay UE (re-)selects to another cell after a remote UE receives CHO configuration(s) before executing a CHO, and which introduces new trigger condition(s) to transmitting a notification message if the CHO configuration(s) is configured to the relay UE. Referring to FIG. 3, remote UE 301, relay UE 302, and BS 303 may function as UE 101, relay UE 103, and BS 102 shown in FIG. 1, respectively. In particular, exemplary procedure 300 includes following steps.

In Step 311, remote UE 301 accesses BS 303 via relay UE 302, e.g., which is a L2 U2N relay UE. In other words, remote UE 301 accesses a serving cell of BS 303 via an indirect path. For example, BS 303 may transmit an indication to indicate whether the L2 U2N relay UE is supported or not.

In Step 312, BS 303 transmits an RRC reconfiguration message to remote UE 301. In some embodiments, the RRC reconfiguration message may include at least one of the following configurations:
(1) Relay operation related configuration(s) used by remote UE 301. For example, the RRC reconfiguration message to remote UE 301 includes sl-L2RemoteConfig information element (IE). The sl-L2RemoteConfig IE may contain L2 U2N relay operation related configuration(s) used by L2 U2N remote UE (e.g., remote UE 301).
(2) Configuration(s) related to a paging message. For example, the RRC reconfiguration message to remote UE 301 includes dedicatedPagingDelivery IE. The dedicatedPagingDelivery IE may be used to transfer a paging message to a relay UE (e.g., relay UE 302) which is in RRC_CONNECTED state.
(3) CHO configuration(s) associated with candidate cell(s). For example, the RRC reconfiguration message including reconfigurationWithSync IE including conditionalReconfiguration IE will be transmitted from BS 303 to remote UE 301. The CHO configuration(s) is included in conditionalReconfiguration IE.

In Step 313, BS 303 transmits an RRC reconfiguration message to relay UE 302. In some embodiments, the RRC reconfiguration message may include at least one of the following configurations:
(1) CHO configuration(s) associated with candidate cell(s). For example, the RRC reconfiguration message including reconfigurationWithSync IE including conditionalReconfiguration IE will be transmitted from BS 303 to relay UE 302. The CHO configuration(s) is included in conditionalReconfiguration IE.
(2) Relay operation related configuration(s) used by relay UE 302. For example, the RRC reconfiguration message to relay UE 302 includes sl-L2RelayConfig IE. The sl-L2RelayConfig IE may contain L2 U2N relay operation related configuration(s) used by L2 U2N relay UE (e.g., relay UE 302).

In Step 314, relay UE 302 transmits a notification message to remote UE 301, when at least one of the following conditions is fulfilled:
(1) upon a reception of an RRC reconfiguration message including a reconfiguration synchronization IE, e.g., reconfiguration WithSync IE;
(2) upon declaring an RLF on a Uu link of relay UE 302;
(3) upon a cell (re-)selection of relay UE 302;
(4) upon an execution of a handover, e.g., an execution of RRCReconfiguration including the reconfiguration WithSync; or
(5) upon an execution of a CHO.

In Step 315, remote UE 301 initiates an RRC reestablishment procedure after remote UE 301 receives the notification message from relay UE 302. There may be following two options in different embodiments, i.e., Option 1 and Option 2.
(1) In some embodiments, in Option 1 of Step 315, after remote UE 301 receives CHO configuration(s), remote UE 301 starts to evaluate CHO execution condition(s). Once receiving the notification message (which may include at least one indication of a cell (re-)selection, a handover, or a Uu RLF of relay UE 302) from relay UE 302, remote UE 301 may stop evaluating the CHO execution condition(s).
(2) In some embodiments, in Option 2 of Step 315, after remote UE 301 receives CHO configuration(s), remote UE 301 starts to evaluate CHO execution condition(s). Once receiving the notification message (which may include at least one indication of a cell (re-)selection, a handover, or a Uu RLF of relay UE 302) from relay UE 302, remote UE 301 may continue to evaluate the CHO execution condition(s). But, remote UE 301 will not execute a CHO even the CHO execution condition(s) is met.

In Step 315, in some embodiments, once remote UE 301 initiates the RRC reestablishment procedure, remote UE 301 shall release sl-L2RemoteConfig IE which is received in Step 312, if remote UE 301 is not configured with conditionalReconfiguration IE, e.g., in Step 312.

In some embodiments, after Step 315, in response to initiating the RRC reestablishment procedure, remote UE 301 performs a cell (re-)selection. In a case that the (re-)selected cell is not a CHO candidate cell and in a case that CHO configuration(s) is configured to remote UE 301, remote UE 301 may release the relay operation related configuration(s) used by remote UE 301 (e.g., sl-L2RemoteConfig), if configured, e.g., in Step 312. In some embodiments, sl-L2RemoteConfig IE includes configuration(s) associated with Sidelink Relay Adaptation Protocol (SRAP), which is used to set the configurable SRAP parameters used by L2 U2N Relay UE (e.g., relay UE 302) and L2 U2N Remote UE (e.g., remote UE 301).
(1) For instance, as specified in 3GPP standard document TS38.351, the configuration(s) of SRAP entity for U2N Remote UE may include at least one of:
   a) Mapping from an radio bearer identified by BEARER ID to egress PC5 RLC (radio link control) channel via RRC.
   b) The local identity via RRC.
(2) For instance, as specified in 3GPP standard document TS38.351, the configuration(s) of SRAP entity for U2N Relay UE may include at least one of:
   a) The local identity for each U2N Remote UE via RRC.
   b) Mapping from UE ID and BEARER ID to egress Uu RLC channel for each U2N Remote UE via RRC.
   c) Mapping from UE ID and BEARER ID to egress PC5 RLC channel for each U2N Remote UE via RRC.

In Step 316, remote UE 301 transmits an RRC reestablishment request message after remote UE 301 initiates the RRC reestablishment procedure.

It should be appreciated by persons skilled in the art that the sequence of the operations in exemplary procedure 300 in FIG. 3 may be changed and some of the operations in exemplary procedure 300 in FIG. 3 may be eliminated or modified, without departing from the spirit and scope of the disclosure.

FIG. 4 illustrates a flow chart of an exemplary procedure 400 of wireless communications in accordance with some embodiments of the present disclosure. Details described in all other embodiments of the present disclosure are applicable for the embodiments shown in FIG. 4.

Exemplary procedure 400 refers to a scenario which handles the case that a relay UE (re-)selects to another cell after a remote UE reports measurement results. Referring to FIG. 4, remote UE 401, relay UE 402, and BS 403 may function as UE 101, relay UE 103, and BS 102 shown in FIG. 1, respectively. In particular, exemplary procedure 400 includes following steps.

In Step 411, remote UE 401 accesses BS 403 via relay UE 402, e.g., which is a L2 U2N relay UE. In other words, remote UE 401 accesses a serving cell of BS 403 via an indirect path. For example, BS 403 may transmit an indication to indicate whether the L2 U2N relay UE is supported or not.

In Step 412, BS 403 transmits an RRC reconfiguration message to remote UE 401. In some embodiments, the RRC reconfiguration message may include at least one of the following configurations:
(1) Measurement configuration(s).
(2) Relay operation related configuration(s) used by remote UE 401. For example, the RRC reconfiguration message to remote UE 401 includes sl-L2RemoteConfig information element (IE). The sl-L2RemoteConfig IE may contain L2 U2N relay operation related configuration(s) used by L2 U2N remote UE (e.g., remote UE 401).
(3) Configuration(s) related to a paging message. For example, the RRC reconfiguration message to remote UE 401 includes dedicatedPagingDelivery IE. The dedicatedPagingDelivery IE may be used to transfer a paging message to a relay UE (e.g., relay UE 402) which is in RRC_CONNECTED state.
(4) An indication to indicate whether remote UE 401 is triggered to report a measurement result of a candidate relay UE in response to identifying a cell change of the candidate relay UE. For example, BS 403 will configure an indication to indicate whether UE is triggered to report a measurement result including ID information of a new serving cell of the candidate relay UE. For example, this indication may be included in report configuration(s).

In Step 413, remote UE 401 performs a measurement and reports measurement result(s) to the serving cell of BS 403. In some embodiments, the measurement result(s) may include at least one candidate relay UE and corresponding serving cell information. In an embodiment, the measurement result(s) includes: (1) the channel quality of the link between remote UE 401 and a candidate relay UE, (2) ID information of the candidate relay UE, and/or (3) ID information of a serving cell of the candidate relay UE. For instance, the ID information of the serving cell of the candidate relay UE includes at least one of: a new radio cell identity (NCI); a cell ID; or a public land mobile network (PLMN) ID.

In Step 414, after remote UE 401 reports the measurement result(s) including at least one candidate relay UE and corresponding serving cell information, the serving cell of the at least one candidate relay UE may change. Remote UE 401 can identify a cell change of the at least one candidate relay UE after monitoring a discovery message from the candidate relay UE. In some embodiments, the cell change of the candidate relay UE will trigger remote UE 401 to transmit measurement result(s) including ID information of the new serving cell of the candidate relay UE. For instance, the ID information of the new serving cell of the candidate relay UE includes at least one of: a NCI; a cell ID; or a PLMN ID.

In Step 415, after remote UE 401 receives the discovery message from the at least one candidate relay UE, remote UE 401 is trigged to report the measurement result(s) of the at least one candidate relay UE to the serving cell of BS 403.

It should be appreciated by persons skilled in the art that the sequence of the operations in exemplary procedure 400 in FIG. 4 may be changed and some of the operations in exemplary procedure 400 in FIG. 4 may be eliminated or modified, without departing from the spirit and scope of the disclosure.

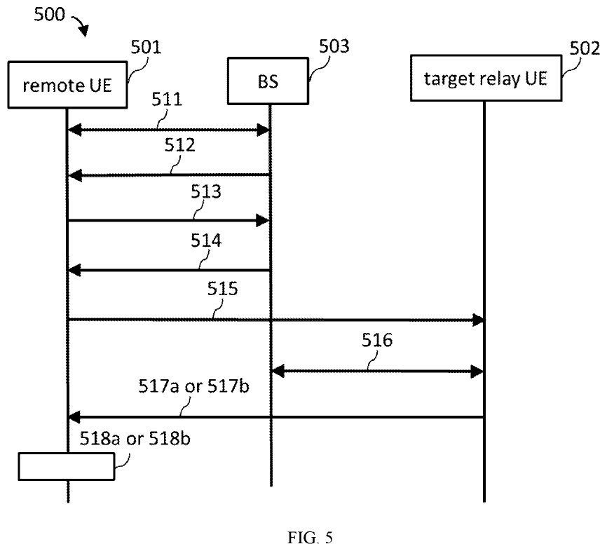

FIG. 5 illustrates a flow chart of an exemplary procedure 500 of wireless communications in accordance with some embodiments of the present disclosure. Details described in all other embodiments of the present disclosure are applicable for the embodiments shown in FIG. 5.

Exemplary procedure 500 refers to a scenario which study new behaviour(s) and/or indication(s) of a remote UE and a relay UE in a direct-to-indirect path switch case or an indirect-to-indirect path switch case in which the relay UE may fail to establish a Uu connection. The following texts describe specific Embodiments 1 and 2 of exemplary procedure 500, in which a remote UE, a relay UE, and a network node (e.g., a BS) perform following operations.

### Embodiment 1

Embodiment 1 refers to a direct-to-indirect path switch case in which a target relay UE may fail to establish a Uu connection. For example, in Embodiment 1, remote UE 501 and BS 503 may function as UE 101 and BS 102 shown in FIG. 1, respectively, and target relay UE 502 (e.g., a L2 U2N relay UE) may be a candidate relay UE not shown in FIG. 1. In particular, following steps may be performed in Embodiment 1.
(1) In Step 511, remote UE 501 accesses BS 503 via a direct path (i.e., a Uu interface). For example, BS 503 may transmit an indication to indicate whether the L2 U2N relay UE is supported or not.
(2) In Step 512, BS 503 transmits an RRC reconfiguration message to remote UE 501. In some embodiments, the RRC reconfiguration message may include measurement configuration(s).
(3) Step 513, remote UE 501 performs a measurement and reports measurement results(s) to the serving cell of BS 503. In some embodiments, the measurement result(s) includes the channel quality of the link between remote UE 501 and a candidate relay UE (e.g., target relay UE 502 shown in FIG. 5) and ID information of the candidate relay UE, and/or ID information of a serving cell of the candidate relay UE. For instance, the ID information of the serving cell of the candidate relay UE includes at least one of: a NCI; a cell ID; or a PLMN ID. Target relay UE 502 may also be named as “candidate target relay UE 502” or “target candidate relay UE 502” or the like.
(4) Step 514, the serving cell of BS 503 may transmit a path switch command including the ID information of target relay UE 502 to remote UE 501.
(5) Step 515, remote UE 501 establishes a PC5 RRC connection towards target relay UE 502. In some embodiments, remote UE 501 starts a timer associated with path switch towards target relay UE 502. In an embodiment of the direct-to-indirect path switch case, the timer may be named as “a timer for path switch to a target relay UE” or “a timer for path switch from direct path to indirect path” or the like. In this embodiment, the source path of the path switch is a direct path, and the target path of the path switch is an indirect path, via target relay UE 502.
   In some embodiments, remote UE 501 will stop the timer associated with path switch towards target relay UE 502 (e.g., the timer for path switch from direct path to indirect path), once the PC5 RRC connection towards target relay UE 502 is established or a complete message of PC5 RRC connection establishment is transmitted.
(6) Step 516, if target relay UE 502 is in RRC_IDLE or RRC_INACTIVE state, target relay UE 502 will establish the Uu connection. In some embodiments, target relay UE 502 may receive a rejection message from the serving cell of BS 503.
(7) After Step 516, there may be following two cases in different embodiments, i.e., Case 1 and Case 2. In Case 1, both Step 517a and 518a are performed. In Case 2, both Step 517b and 518b are performed.
   1) Case 1:
      Step 517a: Once target relay UE 502 in RRC_IDLE or RRC_INACTIVE state will be rejected by the serving cell of BS 503, target relay UE 502 transmits a notification message to remote UE 501. For instance, the notification message includes at least one indication of: an RRC connection establishment failure, or a rejection of RRC connection establishment.
      Step 518a: Once remote UE 501 receives the notification message, remote UE 501 initiates an RRC reestablishment procedure.
   2) Case 2:
      Step 517b: Once target relay UE 502 in RRC_IDLE or RRC_INACTIVE state will be rejected by the serving cell of BS 503, target relay UE 502 is triggered to release the PC5 RRC connection between remote UE 501 and target relay UE 502. For example, target relay UE 502 is triggered to transmit a message to release PC5 RRC connection, e.g., a PC5-S release message.
      Step 518b: Once remote UE 501 receives the message to release PC5 RRC connection, remote UE 501 initiates an RRC reestablishment procedure.

### Embodiment 2

Embodiment 2 refers to an indirect-to-indirect path switch case in which a target relay UE may fail to establish a Uu connection. For example, in Embodiment 1, remote UE 501 and BS 503 may function as UE 101 and BS 102 shown in FIG. 1, respectively, and target relay UE 502 (e.g., a L2 U2N relay UE) may be a candidate relay UE not shown in FIG. 1. In particular, following steps may be performed in Embodiment 2.
(1) In Step 511, remote UE 501 accesses BS 503 via an indirect path via a relay UE (e.g., relay UE 103 as shown in FIG. 1, which may be a L2 U2N relay UE). For example, BS 503 may transmit an indication to indicate whether the L2 U2N relay UE is supported or not.
(2) In Step 512, BS 503 transmits an RRC reconfiguration message to remote UE 501. In some embodiments, the RRC reconfiguration message may include at least one of the following configurations.
   1) Measurement configuration(s).
   2) Relay operation related configuration(s) used by remote UE 501. For example, the RRC reconfiguration message to remote UE 501 includes sl-L2RemoteConfig information element (IE). The sl-L2RemoteConfig IE may contain L2 U2N relay operation related configuration(s) used by L2 U2N remote UE (e.g., remote UE 501).
   3) Configuration(s) related to a paging message. For example, the RRC reconfiguration message to remote UE 501 includes dedicatedPagingDelivery IE. The dedicatedPagingDelivery IE may be used to transfer a paging message to a relay UE which is in RRC_CONNECTED state.
   4) Secondary Cell Group (SCG) configuration(s): in the case of dual-connectivity (DC), a group of serving cells associated with the secondary node, comprising of the SpCell (PSCell) and optionally one or more Scells. In the case of DC, the secondary node refers to the radio access node, with no control plane connection to the core network, providing additional resources to remote UE 501.
(3) Step 513, remote UE 501 performs a measurement and reports measurement results(s) to the serving cell of BS 503. In some embodiments, the measurement result(s) includes the channel quality of the link between remote UE 501 and a candidate relay UE (e.g., target relay UE 502 shown in FIG. 5) and ID information of the candidate relay UE, and/or ID information of a serving cell of the candidate relay UE. For instance, the ID information of the serving cell of the candidate relay UE includes at least one of: a NCI; a cell ID; or a PLMN ID. Target relay UE 502 may also be named as “candidate target relay UE 502” or “target candidate relay UE 502” or the like.
   In the case of multi-radio dual connectivity (MR-DC), upon a random access problem indication from SCG MAC (medium access control) while a handover timer (e.g., timer T304) is not running, remote UE 501 considers that a radio link failure is to be detected for the SCG, i.e., SCG radio link failure (RLF). Then, remote UE 501 will initiate the SCG failure information procedure.
(4) Step 514, the serving cell of BS 503 transmits a path switch command including the ID information of target relay UE 502 to remote UE 501.
(5) Step 515, remote UE 501 establishes a PC5 RRC connection towards target relay UE 502. In some embodiments, remote UE 501 starts timer associated with path switch towards target relay UE 502. In an embodiment of the indirect-to-indirect path switch case, the timer may be named as “a timer for path switch from a source relay UE to a target relay UE” or “a timer for path switch from indirect path to indirect path” or the like. In this embodiment, both the source path and the target path of the path switch are indirect paths.
   In some embodiments, remote UE 501 will stop the timer associated with path switch towards target relay UE 502 (e.g., the timer for path switch from indirect path to indirect path), once the PC5 RRC connection towards target relay UE 502 is established or a complete message of PC5 RRC connection establishment is transmitted.
(6) Step 516, if target relay UE 502 is in RRC_IDLE or RRC_INACTIVE state, target relay UE 502 will establish the Uu connection. In some embodiments, target relay UE 502 may receive a rejection message from the serving cell of BS 503.
(7) After Step 516, there may be following two cases in different embodiments, i.e., Case 1 and Case 2. In Case 1, both Step 517a and 518a are performed. In Case 2, both Step 517b and 518b are performed.
   1) Case 1:
      Step 517a: Once target relay UE 502 in RRC_IDLE or RRC_INACTIVE state will be rejected by the serving cell of BS 503, target relay UE 502 transmits a notification message to remote UE 501. For instance, the notification message includes at least one indication of: an RRC connection establishment failure, or a rejection of RRC connection establishment.
      Step 518a: Once remote UE 501 receives the notification message, remote UE 501 initiates an RRC reestablishment procedure.
   2) Case 2:
      Step 517b: Once target relay UE 502 in RRC_IDLE or RRC_INACTIVE state will be rejected by the serving cell of BS 503, target relay UE 502 is triggered to release the PC5 RRC connection between remote UE 501 and target relay UE 502. For example, target relay UE 502 is triggered to transmit a message to release PC5 RRC connection, e.g., a PC5-S release message.
      Step 518b: Once remote UE 501 receives the message to release PC5 RRC connection, remote UE 501 initiates an RRC reestablishment procedure.

It should be appreciated by persons skilled in the art that the sequence of the operations in exemplary procedure 500 in FIG. 5 may be changed and some of the operations in exemplary procedure 500 in FIG. 5 may be eliminated or modified, without departing from the spirit and scope of the disclosure.

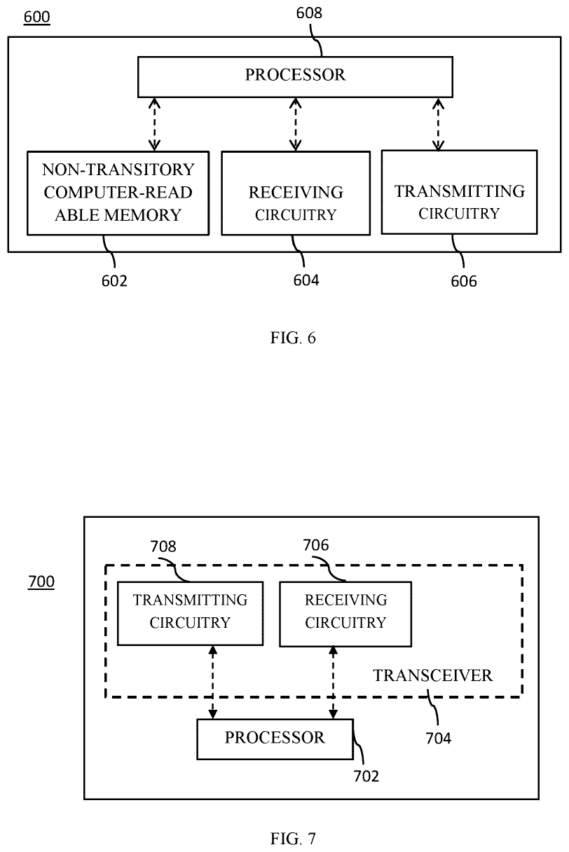

Some embodiments of the present application also provide a wireless communication apparatus for a L2 U2N relay case. For example, FIG. 6 illustrates an exemplary block diagram of an apparatus 600 for a L2 U2N relay case according to some embodiments of the present application.

As shown in FIG. 6, the apparatus 600 may include at least one non-transitory computer-readable medium 602, at least one receiving circuitry 604, at least one transmitting circuitry 606, and at least one processor 608 coupled to the non-transitory computer-readable medium 602, the receiving circuitry 604 and the transmitting circuitry 606. The at least one processor 608 may be a CPU, a DSP, a microprocessor etc. The apparatus 600 may be a network apparatus (e.g., a BS) or a UE (e.g., a remote UE or a relay UE) configured to perform a method illustrated in the above or the like.

Although in this figure, elements such as the at least one processor 608, receiving circuitry 604, and transmitting circuitry 606 are described in the singular, the plural is contemplated unless a limitation to the singular is explicitly stated. In some embodiments of the present application, the receiving circuitry 604 and the transmitting circuitry 606 can be combined into a single device, such as a transceiver. In certain embodiments of the present application, the apparatus 600 may further include an input device, a memory, and/or other components.

In some embodiments of the present application, the non-transitory computer-readable medium 602 may have stored thereon computer-executable instructions to cause a processor to implement the methods with respect to a remote UE, a relay UE, or a network apparatus (e.g., a BS) as described or illustrated above in any of FIGS. 3-5. For example, the computer-executable instructions, when executed, cause the processor 608 interacting with receiving circuitry 604 and transmitting circuitry 606, so as to perform the steps with respect to a remote UE, a relay UE, or a network apparatus (e.g., a BS) as described or illustrated above in any of FIGS. 3-5.

FIG. 7 illustrates a further exemplary block diagram of an apparatus 700 for a L2 U2N relay case according to some embodiments of the present application.

Referring to FIG. 7, the apparatus 700, for example a BS or a UE, may include at least one processor 702 and at least one transceiver 704 coupled to the at least one processor 702. The transceiver 704 may include at least one separate receiving circuitry 706 and transmitting circuitry 708, or at least one integrated receiving circuitry 706 and transmitting circuitry 708. The at least one processor 702 may be a CPU, a DSP, a microprocessor etc.

According to some other embodiments of the present application, when the apparatus 700 is a remote UE, the processor 702 may be configured: to access a serving cell via a direct path or an indirect path, wherein the indirect path is associated with a relay UE; and to receive an radio resource control (RRC) reconfiguration message via the transceiver 704 from the serving cell, wherein the RRC reconfiguration message includes at least one indication of: a measurement configuration; a conditional handover (CHO) configuration associated with at a candidate cell; an indication indicating whether the UE is triggered to report a measurement result of a candidate relay UE in response to identifying a cell change of the candidate relay UE; or a relay operation related configuration used by remote UE in response to accessing the serving cell via the indirect path.

According to some embodiments of the present application, when the apparatus 700 is a relay UE, the processor 702 is configured: to receive an radio resource control (RRC) reconfiguration message via the transceiver 704 from a serving cell, wherein the RRC reconfiguration message includes at least one of: a conditional handover (CHO) configuration associated with a candidate cell; or a relay operation related configuration used by relay UE; and to transmit a notification message via the transceiver 704 to a remote UE via a PC5 link, when at least one of following conditions is fulfilled: upon declaring an radio link failure (RLF) on a Uu link of the relay UE; upon a reception of an radio resource control (RRC) reconfiguration message including a reconfiguration synchronization information element (IE); upon an execution of a handover; upon an execution of a conditional handover (CHO); upon a cell selection or reselection of the relay UE; upon a rejection from a serving cell for establishing an RRC connection between the relay UE and the serving cell; or upon an RRC connection establishment failure.

According to some embodiments of the present application, when the apparatus 700 is a BS, the processor 702 is configured: to transmit an radio resource control (RRC) reconfiguration message via the transceiver 704 to a user equipment (UE) via a direct path or an indirect path, wherein the indirect path is associated with a relay UE, and wherein the RRC reconfiguration message includes at least one indication of: a measurement configuration; a conditional handover (CHO) configuration associated with at a candidate cell; or an indication indicating whether the UE is triggered to report a measurement result of a candidate relay UE in response to identifying a cell change of the candidate relay UE.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE) for wireless communication, comprising:
at least one memory; and
at least one processor coupled with the at least one memory and configured to cause the UE to:
access a serving cell via a direct path or an indirect path, wherein the indirect path is associated with a relay UE; and
receive a radio resource control (RRC) reconfiguration message from the serving cell, wherein the RRC reconfiguration message includes at least one indication of:
a measurement configuration;
a conditional handover (CHO) configuration associated with a candidate cell;
an indication indicating whether the UE is triggered to report a measurement result of a candidate relay UE in response to identifying a cell change of the candidate relay UE; or
a relay operation related configuration used by a remote UE in response to accessing the serving cell via the indirect path.

2. The UE of claim 1, wherein the at least one processor is further configured to cause the UE to receive a notification message from the relay UE, and wherein the notification message includes at least one indication of:
the relay UE handover;
a radio link failure (RLF) on a Uu link of the relay UE;
a cell selection or reselection of the relay UE;
a rejection of RRC connection establishment; or
an RRC connection establishment failure.

3. The UE of claim 2, wherein the RRC reconfiguration message including the CHO configuration is received via the indirect path from the serving cell, and wherein the at least one processor is further configured to cause the UE to start to evaluate at least one execution condition associated with the candidate cell in response to the RRC reconfiguration message including the CHO configuration.

4. The UE of claim 3, wherein, in response to receiving the notification message from the relay UE, the at least one processor is further configured cause the UE to:
stop to evaluate the at least one execution condition; or
continue to evaluate the at least one execution condition, and not execute a CHO upon the at least one execution condition being fulfilled.

5. The UE of claim 1, wherein the at least one processor is further configured to cause the UE to receive a message to release a PC5 RRC connection from the relay UE.

6. The UE of claim 2, wherein the at least one processor is further configured to cause the UE to initiate an RRC reestablishment procedure in response to:
receiving the notification message including at least one indication of:
the relay UE handover;
an RLF on a Uu link of the relay UE;
a cell selection or reselection of the relay UE;
the RRC connection establishment failure, or
the rejection of RRC connection establishment; or receiving a message to release a PC5 RRC connection from the relay UE.

7. The UE of claim 6, wherein the at least one processor is further configured to cause the UE to release the relay operation related configuration used by the remote UE, in response to:
the RRC reconfiguration message including the relay operation related configuration used by the remote UE;
an RRC reestablishment procedure being initiated; and
the RRC reconfiguration message not including the CHO configuration.

8. The UE of claim 6, wherein the at least one processor is further configured to cause the UE to:
in response to initiating the RRC reestablishment procedure, perform a cell selection; and
in response to the RRC reconfiguration message including the relay operation related configuration used by the remote UE, in response to a CHO configuration being configured to the remote UE and in response to a selected cell being not a CHO candidate cell, release the relay operation related configuration used by remote UE.

9. The UE of claim 1, wherein the at least one processor is further configured to cause the UE to report one or more measurement results of one or more candidate relay UEs via the indirect path to the serving cell,
wherein the one or more measurement results of the one or more candidate relay UEs include a measurement result of the candidate relay UE, and wherein the measurement result of the candidate relay UE includes at least one of:
a channel quality of a link between the UE and the candidate relay UE;
identity (ID) information of the candidate relay UE; or
ID information of a first serving cell of the candidate relay UE.

10. The UE of claim 9, wherein the at least one processor is further configured to cause the UE to trigger to report the measurement result of the candidate relay UE, in response to identifying a cell change of the candidate relay UE after reporting the one or more measurement results including the measurement result of the candidate relay UE.

11. The UE of claim 10, wherein the at least one processor is further configured to cause the UE to receive a discovery message including ID information of a second serving cell of the candidate relay UE from the candidate relay UE.

12. The UE of claim 11, wherein the measurement result of the candidate relay UE includes the ID information of the second serving cell, and wherein the cell change of the candidate relay UE is identified after receiving the discovery message.

13. A relay user equipment (UE) for wireless communication, comprising:
at least one memory; and
at least one processor coupled with the at least one memory and configured to cause the UE to:
receive a radio resource control (RRC) reconfiguration message from a serving cell, wherein the RRC reconfiguration message includes at least one of:
a conditional handover (CHO) configuration associated with a candidate cell; or
a relay operation related configuration used by a relay UE; and
transmit a notification message to a remote UE via a PC5 link, when at least one of multiple conditions is fulfilled, wherein the multiple conditions include:
upon declaring an radio link failure (RLF) on a Uu link of the relay UE;
upon a reception of a RRC reconfiguration message including a reconfiguration synchronization information element (IE);
upon an execution of a handover;
upon an execution of a conditional handover (CHO);
upon a cell selection or reselection of the relay UE;
upon a rejection from a serving cell for establishing an RRC connection between the relay UE and the serving cell; or
upon an RRC connection establishment failure.

14. The relay UE of claim 13, wherein the notification message includes at least one indication of:
the relay UE handover;
the RLF on the Uu link of the relay UE;
the cell selection or reselection of the relay UE;
a rejection of RRC connection establishment; or
an RRC connection establishment failure.

15. The relay UE of claim 13, wherein the at least one processor is further configured to cause the relay UE to transmit a message to release a PC5 RRC connection to the remote UE, upon the rejection from the serving cell for establishing the RRC connection.

16. A base station for wireless communication, comprising:
at least one memory; and
at least one processor coupled with the at least one memory and configured to cause the base station to:
transmit a radio resource control (RRC) reconfiguration message to a user equipment (UE) via a direct path or an indirect path, wherein the indirect path is associated with a relay UE, and wherein the RRC reconfiguration message includes at least one indication of:
a measurement configuration;
a conditional handover (CHO) configuration associated with a candidate cell; or
an indication indicating whether the UE is triggered to report a measurement result of a candidate relay UE in response to identifying a cell change of the candidate relay UE.

17. The base station of claim 16, wherein the at least one processor is further configured to cause the base station to receive one or more measurement results of one or more candidate relay UEs from the UE via the indirect path,
wherein the one or more measurement results of the one or more candidate relay UEs include a measurement result of the candidate relay UE, and wherein the measurement result of the candidate relay UE includes at least one of:
a channel quality of a link between the UE and the candidate relay UE;
identity (ID) information of the candidate relay UE; or
ID information of a first serving cell of the candidate relay UE.

18. A processor for wireless communication, comprising:
at least one controller coupled with at least one memory and configured to cause the processor to:
access a serving cell via a direct path or an indirect path, wherein the indirect path is associated with a relay UE; and
receive a radio resource control (RRC) reconfiguration message from the serving cell, wherein the RRC reconfiguration message includes at least one indication of:
a measurement configuration;
a conditional handover (CHO) configuration associated with a candidate cell;
an indication indicating whether the UE is triggered to report a measurement result of a candidate relay UE in response to identifying a cell change of the candidate relay UE; or
a relay operation related configuration used by a remote UE in response to accessing the serving cell via the indirect path.

19. The processor of claim 18, wherein the at least one controller is further configured to cause the processor to receive a notification message from the relay UE, and wherein the notification message includes at least one indication of:
the relay UE handover;
a radio link failure (RLF) on a Uu link of the relay UE;
a cell selection or reselection of the relay UE;
a rejection of RRC connection establishment; or
an RRC connection establishment failure.

20. The processor of claim 18, wherein the at least one controller is further configured to cause the processor to receive a message to release a PC5 RRC connection from the relay UE.
